(19) United States
(12) Patent Application Publication
(10) Pub. No.: US 2014/0046878 A1
(43) Pub. Date: Feb. 13, 2014

(54) METHOD AND SYSTEM FOR DETECTING SOUND EVENTS IN A GIVEN ENVIRONMENT

(71) Applicant: THALES, Neuilly-sur-Seine (FR)

(72) Inventors: Sebastien LECOMTE, Gennevilliers (FR); Francois CAPMAN, Gennevilliers (FR); Bertrand RAVERA, Gennevilliers (FR); Regis LENGELLE, Troyes (FR); Cedric RICHARD, Nice (FR)

(21) Appl. No.: 13/962,866

(22) Filed: Aug. 8, 2013

(30) Foreign Application Priority Data
Aug. 10, 2012 (FR) 12 02223

(51) Int. Cl. G06N 99/00

(52) U.S. Cl. CPC G06N 99/005
USPC 706/12

(57) ABSTRACT

A method and system for detecting abnormal events in a given environment comprises a model construction step comprising: a) a step of unsupervised initialization of Q groups; b) a step of definition of a model of normality consisting of 1-class SVM classifiers; c) a step of optimum distribution of the audio signals in the Q different groups; d) repetition of the steps b and c until a stop criterion C₁, is checked and a model M is obtained; and a step of use of the model(s) M obtained from the construction step comprising the analysis of an unknown audio signal S_{T} assigning a score to a 1-class SVM classifier, and a comparison of all the scores fq obtained using decision rules in order to determine the presence or absence of an anomaly in the audio signal analyzed.

### CROSS-REFERENCE TO RELATED APPLICATION

This application claims priority to foreign French patent application No. FR 1202223, filed on Aug. 10, 2012, the disclosure of which is incorporated by reference in its entirety.

### FIELD OF THE INVENTION

The invention relates to a system and a method that make it possible to detect sound events. It makes it possible notably to analyze audio signals and to detect signals considered to be abnormal compared to a usual sound environment, called ambiance.

The invention applies notably to the fields of the monitoring and analysis of environments, for applications for monitoring areas, places or spaces.

### BACKGROUND

In the field of the monitoring and analysis of environments, the conventional systems known from the prior art rely mainly on image and video technologies. In applications for recognizing sound phenomena in an audio stream, the problems to be solved are notably as follows:
1) how to detect specific and/or abnormal sound events,
2) how to obtain solutions that are robust to the background noise (or ambiance) and to its variabilities, that is to say solutions which are reliable and which do not generate alarm signals continually and accidentally,
3) how to classify the different abnormal events.

In the field of the monitoring and analysis of sound events, the prior art differentiates between two processes. The first process is a detection process, the second is a process of classification of the events detected.

In the prior art, the sound event detection methods rely generally on the extraction of parameters characteristic of the signals that are to be detected while the classification methods are generally based on so-called “supervised” approaches in which a model for each event is obtained from segmented and labelled learning data. These solutions rely, for example, on classification algorithms known to a person skilled in the art, by the abbreviations Hmm, for Hidden Markov Model, GMM for Gaussian Mixture Model, SVM for Support Vector Machine or NN for Neural Network. The proximity of the real test data and of the learning data conditions performance levels of these classification systems.

These models, despite their performance levels, do however present drawbacks. They in fact require the prior specification of the abnormal events and the collection of a sufficient quantity of data statistically representative of these events. The specification of the events is not always possible nor is the collection of a sufficient number of embodiments to enrich a database. It is also necessary, for each configuration, to proceed with a new supervised learning. The supervision task requires human intervention, for example, a manual or semi-automatic segmentation, a labelling, etc. The flexibility of these solutions is therefore limited in terms of usage, and the inclusion of new environments is difficult to implement, the models obtained being correlated to the ambiance affecting the learning signals.

The publication entitled “Abnormal Events Detection Using Unsupervised One-Class SVM-Application to Audio Surveillance and Evaluation” by Lecomte et al., IEEE In Advanced Video and Signal based Surveillance, 2011, AVSS 2011, discloses a method that relies on a 1-class SVM modelling. This method offers a single and global model for all the ambiance (“normal” class). The model is difficult to exploit to improve the classification performance levels.

The patent application EP 2422301 is based on a modelling of the normal class by a GMM set.

### DEFINITIONS

The description of the invention involves definitions which are explained below.

The signals processed are audio signals obtained from acoustic sensors. These signals are represented by a set of physical quantities (time, frequency or a combination), mathematical quantities, statistical quantities or other quantities, called descriptors.

The extraction of the descriptors is performed on successive portions, with or without overlapping of the audio stream. For each of these portions, called frame, a descriptor vector is extracted.

The space in which each frame of an audio stream is represented by its descriptor vector is called observation space. Such a vector can be seen as a “point” of the observation space whose dimensions correspond to the descriptors.

A set of consecutive frames is called signal segment, a segment can be represented by the set of the vectors extracted from the frames forming this segment. The segmentation information is extracted by analysis of the audio signal or of the descriptor vectors and denotes a similarity between the successive frames which make up said segment.

The term “audio data” will now be defined. Depending on the context, it may designate the descriptor vector extracted from a signal frame, or the set of the descriptor vectors extracted from the frames that make up a signal segment, or even the single vector representing a segment of the signal (for example a vector of the average or median values of the descriptors extracted from the frames that make up this segment). “Representation” of a signal is a term also used to describe the set of audio data corresponding to this signal.

The process as a whole, consisting in extracting the audio data (vectors and, where appropriate, segmentation information) from an audio signal, is hereinafter in the description called “extraction of the representation of the signal”.

The invention falls within the technical field of learning and, more particularly, the field of shape recognition. The terminology which will, in this context, be used hereinafter in the description of the invention, will now be specified.

A group is a set of data combined because they share common characteristics (similar parameter values). In the method according to the invention, each subclass of the ambiance signals corresponds to a group of audio data.

A classifier is an algorithm that makes it possible to conceptualize the characteristics of a group of data; it makes it possible to determine the optimum parameters of a decision function during a training step. The decision function obtained makes it possible to determine whether a datum is included or not in the concept defined from the group of training data. In a misuse of language, the term classifier describes both the training algorithm and the decision function itself.

The task subjected to a classifier guides the choice of the latter. In the method according to the present invention, it is specified that the model has to be constructed from just the representation of the learning signals, corresponding to the ambiance. The task associated with the learning of concepts, when only the observations of a single class are available, is called 1-class classification. A model of this set of observations is then constructed in order to then detect which new observations resemble or do not resemble most of this set. It is therefore possible, according to the terminology of the art, to detect aberrant data (outlier detection) or even discover novelty (novelty discovery).

The competitive modelling according to the invention is notably based on the training of a set of 1-class SVM classifiers (each classifier learns a subclass of the ambiance). It should be noted that the support vector machines, or SVM, are a family of classifiers, known to a person skilled in the art.

### SUMMARY OF THE INVENTION

The method according to the invention is an unsupervised method which makes it possible notably to produce a competitive modelling, based on a set of 1-class SVM classifiers, of the data (called learning data) extracted from the audio signals in an environment to be monitored. The model, resulting from the breakdown of the ambiance into subclasses, makes it possible, during the discovery of new data (called tested data) extracted from test signals, to determine whether the audio signal analyzed falls within the “normal” class (ambiance) or the abnormal class (abnormal sound event).

In the application targeted by the present invention, a modelling of the sound environment being monitored is produced from signals recorded in situ, called learning signals. One of the objectives is to be capable of classifying new signals, called test signals, in one of the following “classes”, or categories (examples of sounds are given, by way of illustration and in a nonlimiting manner, for the context of the monitoring of a metro station platform):
“normal signal”: the signal corresponds to the sound ambiance of the environment (for example: train arrival/departure, ventilation systems, discussions between passengers, audible warning of the closure of the doors, service announcements etc.),
“abnormal signal”: the signal corresponds to a sound event that is not usual for the ambiance (for example: gun shots, fights, cries, vandalism, breaking glass, animals, children kicking up a rumpus, etc.).

The assumption is made that little, or even no, abnormal signal is present in the learning signals, in other words, that the abnormal events are rare.

The method according to the invention constructs a model of the ambiance by being robust to the presence of a small quantity of abnormal events in the learning signals. This construction, called “competitive modelling” produces a fine model of the learning signals by breaking down the normal class into “subclasses”, with rejection of the rare signals (assumed abnormal). This breakdown is performed in an unsupervised manner, that is to say that it is not necessary to label the learning signals, or to identify the possible abnormal events present in these learning signals.

Once a model of the ambiance is constructed, the latter is used to evaluate test signals. If a test signal corresponds to a model created, then it is considered to be normal (new realization of an ambiance signal); if it does not correspond to the model, then it is considered to be abnormal. The method according to the invention is also characterized in that it can update a model by taking into account test signals.

The object of the invention relates to a method for detecting abnormal events in a given environment, by analyzing audio signals recorded in said environment, the method comprising a step of modelling a normal ambiance by at least one model and is therefore a step using said model or models, the method comprising at least the following steps: a model construction step comprising at least the following steps:

a) a step of unsupervised initialization of Q groups consisting of a grouping by classes, or subspace of the normal ambiance, of the audio data representing the learning signals S_{A}, Q being set and greater than or equal to 2,
b) a step of definition of a model of normality consisting of 1-class SVM classifiers, each classifier representing a group, each group of learning data defines a sub-class in order to obtain a model of normality consisting of several classifiers of 1-class SVM, each one being adapted to a group, or sub-set of data said to be normal derived from the learning signals representative of the ambiance,
c) a step of optimisation of the groups that uses the model during the modelling step 3.2 so as to redistribute the data in the Q different groups,
d) repetition of the steps b and c until a stop criterion C₁, is checked and a model M is obtained,
the step of use of the model(s) M obtained from the construction step comprising at least the following steps:
e) the analysis of an unknown audio signal S_{T} obtained from the environment to be analyzed, the unknown audio signal is compared to the model M obtained from the model construction step, and assigns, for each 1-class SVM classifier, a score fq, and
f) a comparison of all the scores fq obtained by the 1-class SVM classifiers using decision rules in order to determine the presence or absence of an anomaly in the audio signal analyzed.

According to one embodiment, the audio data being associated with segmentation information, the method assigns a same score value fq to a set of data constituting one and the same segment, a segment corresponding to a set of similar and consecutive frames of the audio signal, said score value being obtained by calculating the average value or the median value of the scores obtained for each of the frames of the signal analyzed.

1-class SVM classifiers are, for example, used with binary constraints.

According to an alternative implementation of the method, a plurality of models Mj are determined, each model being obtained by using different stop criteria C₁ and/or different initializations I, and a single model is retained by using statistical or heuristic criteria.

According to one implementation of the method, a plurality of models Mj are determined and retained during the model construction step, for each of the models Mj, the audio signal is analyzed and the presence or absence of anomalies in the audio signal is determined, then these results are merged or compared in order to decide categorically as to the presence or absence of an anomaly in the signal.

During the group optimization step, the number Q of groups is, for example, modified by creating/deleting one or more groups or subclasses of the model.

During the group optimization step, the number Q of groups is, for example, modified by merging/splitting one or more groups or subclasses of the model.

It is possible to update the model used during the usage step d) by executing one of the following steps: the addition of data or audio signals or acoustic descriptors extracted from the audio signals in a group, the deletion of data in a group, the merging of two or more groups, the splitting of a group into at least two groups, the creation of a new group, the deletion of an existing group, the placing on standby of the classifier associated with a group, the reactivation of the classifier associated with a group.

The method can use, during the step c), a criterion for optimum distribution of the audio signals in the Q different groups chosen from the following list:
the fraction of the audio data which changes group after an iteration below a predefined threshold value,
a maximum number of iterations reached,
a criterion of information on the audio data and the modelling of each group reaching a predefined threshold value.

It is possible to use the K_averages method for the group initialization step.

The invention also relates to a system for determining abnormal events in a given environment, by the analysis of audio signals detected in said environment, characterized in that it comprises at least:
an acoustic sensor for detecting sounds, sound noises present in an area to be monitored linked to a device containing a filter and an analogue-digital converter,
a processor comprising a module for preprocessing the data, and a learning module,
a database, comprising models corresponding to classes of acoustic parameters representative of an acoustic environment considered to be normal,
one or more acoustic sensors each linked to a device comprising a filter and an analogue-digital converter,
a processor comprising a preprocessing module then a module for recognizing processed data, the preprocessing module is linked to the database, adapted to execute the steps of the method,
a means for displaying or detecting abnormal events.

### BRIEF DESCRIPTION OF THE DRAWINGS

Other features and advantages of the device according to the invention will become more apparent on reading the following description of an exemplary embodiment given by way of illustration and in a nonlimiting manner, with appended figures which represent:

FIG. 1, an exemplary detection system according to the invention,

FIG. 2, the succession of the steps implemented by the method according to the invention for the analysis of an audio signal,

FIG. 3, the steps of the competitive modelling according to the invention,

FIG. 4, a succession of steps for optimizing the choice of models,

FIG. 5, an exemplary audio signal analysis process,

FIG. 6, the steps executed during the decision-taking, and

FIG. 7, a representation of a hinge function used in the method according to the invention,

FIG. 8 illustrates the boundary obtained around a class to be modelled.

### DETAILED DESCRIPTION

The following description is given by way of illustration and in a nonlimiting manner for monitoring and detecting abnormal audio events, such as cries, in an environment corresponding, for example to a station or public transport platform.

In order to form the representation space in which the signals will be modelled, the data can be used directly and/or normalized and/or enriched with additional information (moments for all or some of the descriptors) and/or projected into a different representation space and/or sampled, in the latter case only some of the descriptors being retained, the choice being able to be made by an examination or by application of any algorithm for selecting variables (selection of parameters—in the space—or selection of the data—in time) known to a person skilled in the art.

It is proposed, for example, to complement the vectors of parameters of the first (speed) and second (acceleration) derivatives for each of the acoustic descriptors. Also, it is possible to estimate coefficients of normalization on average (null) and variance (unitary) for all of the parameters from the training data, then to apply these coefficients to the training and test data.

When the method uses a step of automatic segmentation of the audio stream, the latter will be able to be done by using, for example, the dendogram principle described in the abovementioned patent application EP2422301. Any other method taking the form of an online process, that is to say in which the processing is performed in real time in order to be capable, in a monitoring context, of segmenting the audio stream into the signals in real time, can be used.

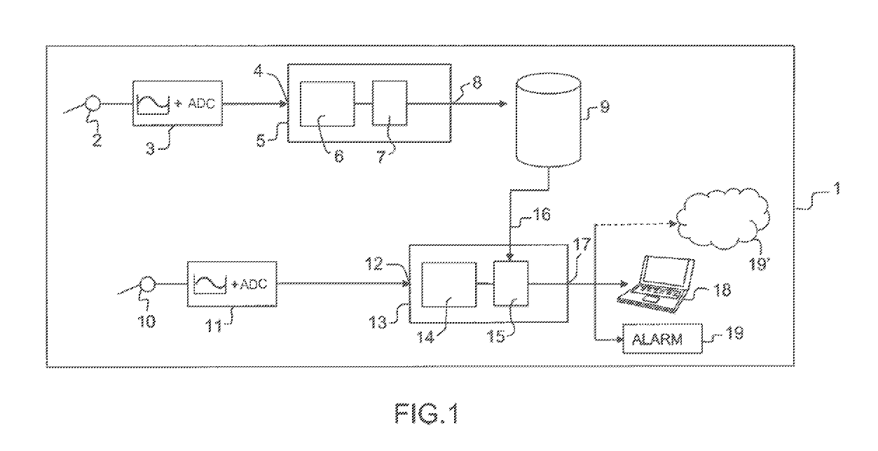

FIG. 1 schematically represents an exemplary architecture of the system making it possible to implement the method according to the invention.

The system comprises at least one acoustic sensor for detecting sounds, sound noises present in an area to be monitored or for which an analysis of sound events is desired. The signals received on this acoustic sensor 2 are transmitted, firstly to a device 3 containing a filter and an analogue-digital converter, or ADC, that are known to a person skilled in the art, then via an input 4 to a processor 5 comprising a module 6 for preprocessing the data, including the extraction of the representation, then a learning module 7. The model generated during a learning phase is transmitted via an output 8 of the processor 5 to a database 9. This database contains one or more models corresponding to one or more acoustic environments that have been learned and considered to be normal. These models are initialized during a learning phase and will be able to updated during the operation of the detection system according to the invention. The database is used for the phase of detection of abnormal sound events.

The system comprises, for the detection of the abnormal audio events, at least one acoustic sensor 10. The acoustic sensor 10 is linked to a device 11 comprising a filter and an analogue-digital converter, or ADC. The data detected by an acoustic sensor and formatted by the filter are transmitted to a processor 13 via an input 12. The processor comprises a preprocessing module 14, the preprocessing including the extraction of the representation, then a detection module 15. The detection module receives the data to be analyzed, and a model from the database, via a link 16 which can be wired or not. On completion of the processing of the information, the result “abnormal audio event” or “normal audio event” is transmitted via the output 17 of the processor either to a device of PC type 18, with display of the information, or to a device triggering an alarm 19 or to a system 19′ for redirecting the video stream and the alarm.

The acoustic sensors 2 and 10 may be sensors having similar or identical characteristics (type, characteristics and positioning in the environment) in order to avoid signal formatting differences between the learning and test phases.

The data can be transmitted between the various devices via wired links, or even wireless systems, such as Bluetooth, WiFi, WiMax, and other such systems.

In the case of a system implementing a single processor, the modules 3 and 5 (as well as the modules 11 and 13) may also be grouped together in one and the same module comprising the respective inputs/outputs 4, 12, 8 and 17.

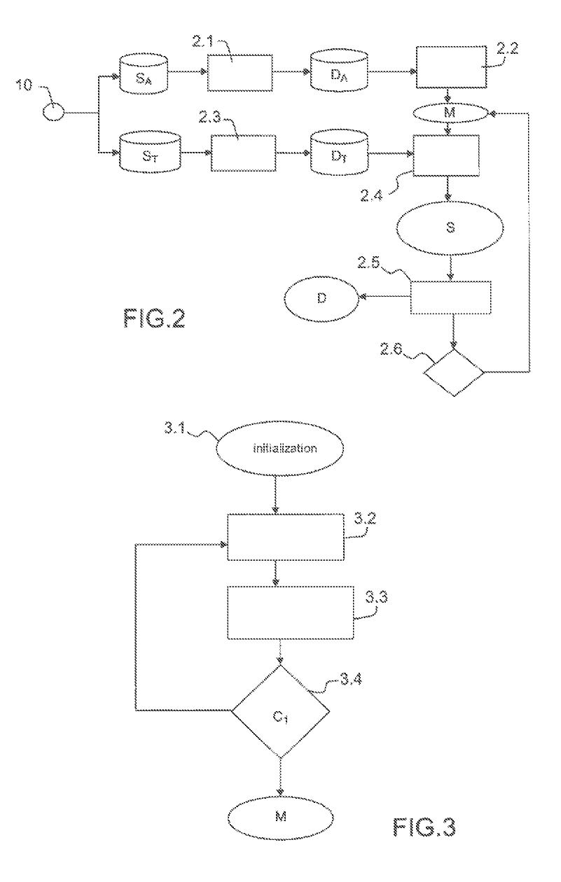

FIG. 2 represents an example of sequencing of the steps implemented by the method according to the invention for, on the one hand, the creation of a model of the ambiance from a learning audio signal, and on the other hand, the execution of the detection of abnormality in a test audio signal.

A first step, 2.1, corresponds to the learning of a model of the ambiance by the system. The system will record, using the acoustic sensor, audio signals corresponding to the noises and/or to the background noise to represent the ambiance of the area to be monitored. The signals recorded are designated learning signals S_{A} of the sound environment. The learning phase is automated and unsupervised. A database (learning data D_{A}) is created by extraction of the representation of the audio signals picked up over the time period T_{A}, in order to arrange learning data. On completion of the step 2.1, the method has a model of the ambiance M, in the form of a set of 1-class SVM classifiers, each optimized for a group of data (or subclass of the “normal” class).

The duration T_{A} over which the learning signals S_{A} are recorded is set initially or during the learning. Typically, a few minutes to a few hours will make it possible to construct a reliable model of the ambiance, depending on the variability of the signals. To set this duration during the learning, it is possible to calculate an information criterion (for example, BIC criterion known to a person skilled in the art) and to stop the recording when a threshold on this criterion is reached.

The second step 2.2 corresponds to a step of analyzing an audio stream. This step comprises a phase of extraction of the acoustic parameters and, possibly, a step of automatic segmentation of the stream being analyzed. These steps are similar to those used for the learning phase, and in this case, the representation extracted from the test signals is called test data D_{T}. The test data D_{T} are compared 2.4 to the model M obtained during the learning step 2.1. The method will use each classifier to assign a score fq for each subclass q=1, etc., Q, by using the decision functions associated with the classifiers. A score is assigned to each test datum. At the output of the analysis step, the method will have a set S of values of scores fq.

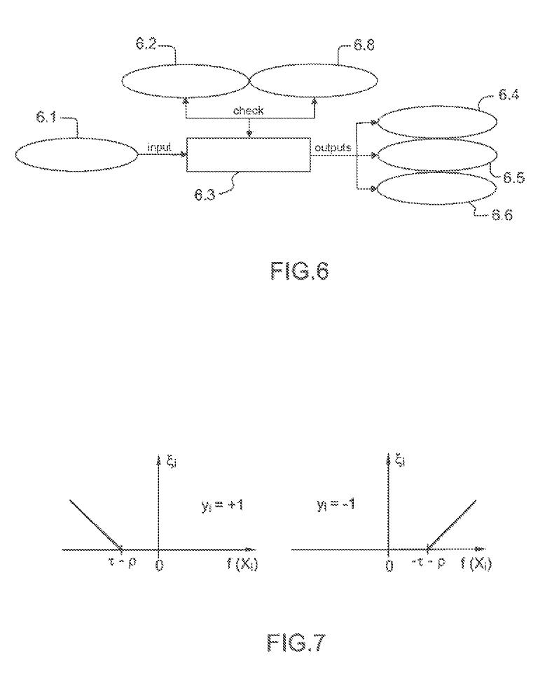

The next step 2.5 is a decision step for determining whether there are abnormalities in the audio signal picked up and analyzed. In the case where the signal belongs to one of the subclasses of the ambiance, or “normal” class, then at least one of the classifiers associates the corresponding datum or data with a high score, and indicates that it or they is or are similar to the learning data. Otherwise, the signals do not form part of a group, in other words the set of classifiers assigns a low score to the corresponding test datum or data and the signals are considered to be abnormal events. Ultimately, the result may take the form of one or more signals associated with the presence or with the absence of audio abnormalities in the audio stream analyzed. This step is described in detail, in conjunction with FIG. 6, hereinbelow in the document.

According to an alternative implementation, an additional step 2.6 of updating of the model M of the ambiance is implemented during the use of the system; that is to say that a model constructed during the learning step can be modified. Said update uses one or more heuristics—based for example on the BIC or AIC information criteria, known to a person skilled in the art—, analyzes the model and determines whether it can or cannot evolve according to one of the following operations (examples of implementation are given by way of illustration and in a nonlimiting manner):
addition of data or acoustic descriptors extracted from the audio signals in a group if, for example, these data have been identified as deriving from a normal signal by the classifier associated with this group,
deletions of data in a group if, for example, these data are derived from old signals and more recent data have been added to the group, or even to maintain a constant number of data in the different groups,
merging of two groups or more if, for example, the ratio of inter-group variance to intra-group variance is below a fixed threshold,
splitting of a group into at least two groups if, for example, the BIC criterion calculated for this group is below a fixed threshold. In this case, an unsupervised grouping step, K-average for example, is carried out for the data of the split group and the criterion is measured again on the groups obtained. The splitting is reiterated until all of the new groups obtain a BIC criterion value above the fixed threshold,
creation of a new group if, for example, for a rejected set of data considered to be a subclass, the value of the BIC information criterion is above a fixed threshold,
deletion of an existing group if, for example, the quantity of data belonging to this group, or the value of the BIC information criterion calculated for this group, is below a fixed threshold. The data of the group that are deleted can then be distributed in other groups or disregarded until the next group optimization step,
the placing of the classifier associated with a group on standby, that is to say that it is no longer used to detect normal data, if, for example, no datum detected as normal has been detected as normal by this classifier during a fixed time period,
the reactivation of the classifier associated with a group, after it has been placed on standby, if, for example, a datum has been detected as abnormal whereas it would have been detected as normal by this classifier.

Optionally, an information criterion, for example BIC, can be calculated for all of the models before and after one of the above operations to validate or cancel the operation by comparing the value obtained by the criterion with a fixed threshold. In this case, the updating is said to be unsupervised because it is entirely determined by the system.

Alternatively, a variant implementation of the invention may be based on the operator or operators supervising the system to validate the updating operations. In this second, supervised embodiment, the operator can notably, for example, control the placing on standby and the reactivation of classifiers associated with subclasses of the normality and thus parameterize the system so that it detects or does not detect certain recurrent events as anomalies.

The competitive modelling used to determine the models used for the analysis of the audio signals is detailed in relation to FIG. 3. This process makes it possible to produce the optimized distribution of the learning data into groups and into joint training of the 1-class SVM classifiers. It is used in the learning step and invoked each time the model is updated.

The competitive modelling is initialized using the set of learning data and a set of labels (corresponding to the groups). In order to determine the labels associated with the data, the latter are distributed into at least two groups. The unsupervised initial grouping of the data (process known by the term clustering) into Q groups (Q≧2) is now discussed. It will notably make it possible to produce a model of the database in Q subclasses.

According to a variant implementation, it is possible that only a part of the learning database is assigned to groups. According to another variant, when a step of automatic segmentation of the audio stream is implemented, it is possible to apply a constraint so that all of the audio data, or descriptor vectors, obtained from one and the same segment are associated with one and the same group. For example, a majority vote will associate all of the vectors obtained from the frames of a given segment to the group with which the greatest number of vectors of this segment are associated individually.

For the initialization 3.1 of the groups, the invention uses the methods known to a person skilled in the art. Examples that can be cited include the K-averages approach or any other space partitioning method. The grouping is done based on acoustic descriptors according to geometrical criteria in the representation space (Euclidian, Bhattacharyya, Mahalanobis distances, known to a person skilled in the art) or on acoustic criteria specifically derived from the signal.

The objective of the step 3.2, or optimization of the model M, is to train the classifiers. Each classifier, a 1-class SVM, is trained on a different group. There are therefore as many classifiers as there are groups, and each group of learning data defines a subclass. On completion of this step, the method has a model of normality made of a plurality of 1-class SVM classifiers, each being adapted to a group, or subset of the data said to be normal derived from the learning signals representative of the ambiance.

The objective of the next step 3.3, or optimization of the groups, is the redistribution of the learning audio data in each group, a label being associated with each learning audio datum. The method according to the invention, to distribute the data in the different groups, uses the model obtained during the model optimization step.

One way of optimizing the labels associated with the data consists, for example, given a model, in executing a decision step. One possibility for redefining the groups is to evaluate the score obtained by the learning data compared to each of the 1-class SVM classifiers obtained during the modelling step 3.2. The data are then redistributed so as to belong to the group for which the score is highest.

When audio signal segmentation of the information is available, it is possible, here again, to force all of the data derived from the frames of one and the same segment to be associated with one and the same group.

According to another variant, when the score of a datum is too low (compared to a fixed or dynamically determined threshold), it is possible to consider this datum as an aberrant point (known in the context of automatic learning by the term outlier), the datum is not then associated with any group. Also, it is possible, if the score of several classifiers is high compared to one or more fixed thresholds, to associate one and the same datum with a plurality of groups. It is possible, finally, to use fuzzy logic elements, known to a person skilled in the art, to grade the membership of a datum to one or more groups. The data associated with no group (called rejected data) are considered to be (rare) examples of an abnormal class. This notably helps to naturally isolate the abnormal data which could be present in the learning set.

The method performs an iterative optimization 3.6 in alternate directions. The model optimization process 3.2 and the group optimization process 3.3 are carried out in turns until a stop criterion C₁ is reached 3.4. The process is qualified as process of optimization in alternate directions because two successive optimizations are performed: on the one hand, the parameters of each of the 1-class SVM classifiers are trained, or estimated, and on the other hand, the distribution of the data in the groups is optimized.

Once the stop criterion C₁ is verified, the model M (set of 1-class SVM classifiers) is retained. For the stop criterion C₁, it is possible to use one of the following criteria:
the fraction of the audio data or of the audio segments which change group after an iteration is below a predefined threshold value, which includes the fact that no datum changes group;
a maximum number of iterations is reached,
a criterion of information (of the BIC or AIC type, known to a person skilled in the art) on the audio data and the modelling of each group reaches a predefined threshold value,
a maximum or minimum threshold value, fixed or not, concerning the set of groups is reached.

Advantageously, the method according to the invention avoids executing a joint optimization known from the prior art exhibiting difficulties in its implementation, because the optimization of the groups and the optimization of the description are rarely of the same type (combinatorial problem for the groups, and generally a quadratic problem for the description). The models are also learned on increasingly less polluted data, the aberrant data (outliers) being rejected, and the models are increasingly accurate. In particular, the boundaries between the subclasses are sharper by virtue of the distribution of the data in each group on the basis of the modelling of each of the subclasses.

According to a variant implementation of the invention, it is possible that, during the group optimization step, the number of groups is modified according to one of the following four operations as described for the process of updating the model during use:
the creation/deletion of groups or subclasses of the model,
the merging/splitting of groups or subclasses of the model.

It will nevertheless be noted that the updating operations during the learning are always carried out in an unsupervised manner, that is to say that no operator intervenes during the construction of the model.

The subclasses of the ambiance are determined in an unsupervised manner and a datum may change group (or subclass) with no consequential effect.

The set of steps 3.2, 3.3, 3.4 and 3.6 is called competitive modelling, because it places the subclasses in competition to know to which group a datum belongs. The model from the competitive modelling is unique for an initialization I and a fixed stop criterion C₁. Examples of how to use different initializations and/or different stop criteria, and process the different models obtained, are given below.

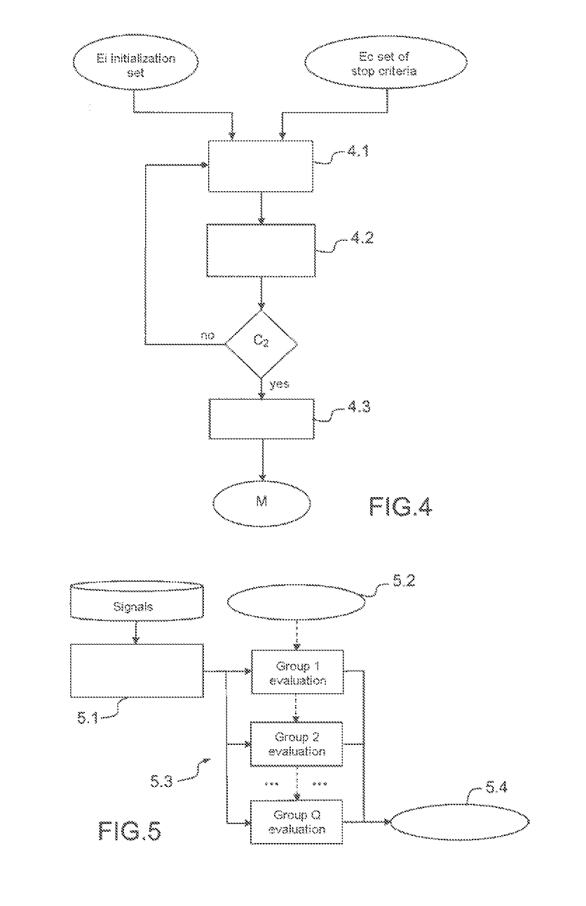

FIG. 4 describes an example, the objective of which is to evaluate a number of initializations I of the groups and/or a number of stop criteria C₁; the different initializations and the different stop criteria are, for example, those proposed at the start of the description of FIG. 3. This process can be implemented when a set of initializations E_{I} and/or a set of stop criteria E_{C} are available. This process comprises, for example, the following steps:
a step, 4.1, of selection of an initialization I and of a stop criterion C₁ from the sets E_{I} and E_{C},
a step, 4.2, of competitive modelling MC as described in FIG. 3, and using the initialization I and the stop criterion C₁ previously selected in the step 4.1,
a decision step based on a stop criterion, C₂, making it possible either to direct the process to a new selection step 4.1, or to terminate the search process,
a step, 4.3, of searching for the optimum model from among those obtained during the different competitive modelling 4.2.

If the number of possible initializations is finite, the stop criterion C₂ can be omitted, which amounts to stopping when all the initialization pairs I/stop criterion C₁ available have been proposed to the competitive modelling 4.2. In this same case, a stop criterion C₂ can make it possible to prematurely stop the search if a sufficiently satisfactory solution has been reached, but this is by no means mandatory. On the other hand, if the number of possible initializations is infinite, the stop criterion C₂ is mandatory. The stop criterion C₂ for example takes one of the following forms:
evaluating the models as they are created and stopping the search when a threshold is reached (information criterion, etc.); this amounts to a method of evaluation and/or of comparison of the different models, as used in the step 4.3,
a limit on the number of different initializations to be evaluated if random initialization methods are used, or if a single method is executed and a parameter is varied (for example, the parameter K of a K-averages approach is incremented to a fixed value),
any other method having the effect either of prematurely stopping the exploration of a finite number of initializations, or of stopping an exploration of an infinite number of explorations.

The objective of the step 4.3, when a plurality of models have been obtained from the different calls to the competitive modelling step 4.2, is to select a single model, for example. The selection works for example, on the basis of information criteria and/or heuristics and/or any other technique that can characterize such a modelling. For example, the information criterion BIC is calculated for each of the models obtained and the model for which the maximum value is selected, that which optimizes the criterion. According to another example, a heuristic consists in retaining the model which requires the fewest support vectors, on average, for the set of 1-class SVM classifiers that make up this model (the notion of support vectors is specified after the detailed presentation of the problem and of the solving algorithm associated with the 1-class SVM classifiers).

According to a variant implementation, a plurality of models can be selected and used to analyze the audio signal in order to decide on the presence or absence of anomalies in the audio signal by applying the steps of the method described above. This multiple selection can work by the use of different methods for selecting the best model, which can, possibly, select the different models. Also, it is possible to retain more than one model according to a selection method (selecting the best). Having a plurality of models makes it possible, among other things, during the decision-taking, to merge the evaluation information obtained from said models, the information corresponding to the presence or absence of anomalies. Decision merging methods, known to a person skilled in the art, are then used. For example, when the analysis of an audio signal with N models has resulted in finding a number X of presence of anomalies in the audio signal analyzed and Y without anomalies, with X less than Y, then the method, according to a majority vote, will consider the signal to be without anomalies.

FIG. 5 schematically represents an example of steps implemented during the step of analyzing the audio signals to be processed S_{T}, using the models generated during the learning step.

On completion of the learning step, each group of data, or subclass, is represented by a 1-class classifier, associated with a decision function for evaluating an audio datum. The score indicates the membership of said datum to the group or subclass represented by the classifier.

During the audio signal analysis step, the actions needed for the representation of the audio signal are carried out in the same configuration as during the learning step: extraction of the parameters, normalization, segmentation, etc.

The step 5.1 is for extracting the audio signal representation information. By means 5.2 of the model M generated by the learning phase (2.2/3.5), the method will evaluate 5.3 the representation information or vectors representing the data of the signal with each of the Q classifiers obtained from the learning step: “group 1” classifier, “group 2” classifier, up to the “group Q” classifier. The evaluation results in a set of scores 5.4 which constitute an additional representation vector which is processed during the decision step used for the detection of abnormal signals.

According to a variant, when the audio data are the vectors extracted for each analyzed signal frame, the scores obtained from the step 5.3 can be integrated on a time support by taking into account the segmentation information. For this, the same score is assigned to all of the audio data (frames in this precise case) that make up one and the same segment This single score is determined from the scores obtained individually by each of the frames. It is proposed, for example, to calculate the average value or even the median value.

FIG. 6 schematically represents the steps executed by the method according to the invention for the decision step. The method takes into account all the scores 6.1 with decision rules 6.2 based, for example, on parameters 6.8 such as thresholds, weights associated with the different rules, etc., to generate, after the decision taking, 6.3, alarm signal states 6.4, generated information 6.5, or actions 6.6.

The alert signals generated are intended for an operator or a third-party system, and can intrinsically be of different kinds, for example: different alarm levels, or indications on the “normal” subclass closest to the alarm signal, or even the action of displaying to an operator all of the cameras monitoring the area in which the acoustic sensor from which the signal detected as abnormal is located.

An example of decision rule is now given. It relies on the comparison of all the score values obtained, for each of the test data, with one or more threshold values Vs set in advance or determined during the learning; for example, a threshold can be set at the value of the 5th percentile for all of the scores obtained on the learning data. The threshold value Vs is in this case one per parameter 6.8 for the decision rule 6.2, which can be expressed as follows: “if at least one classifier assigns a score greater than Vs, then the datum originates from an ambiance signal, otherwise, it is an abnormal signal”.

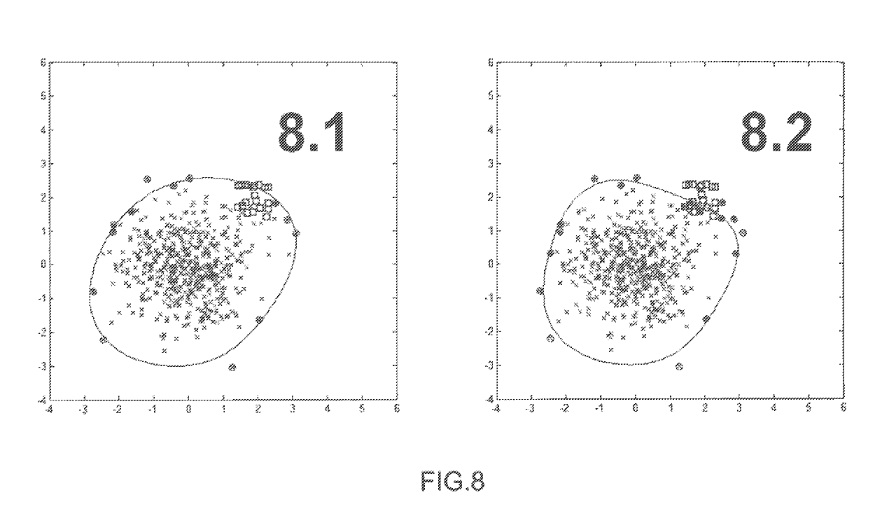

The method according to the invention is based on 1-class SVM classifiers: ν-SVM and SVDD (Support Vector Data Description) are two methods known to a person skilled in the art for constructing a 1-class SVM classifier. We will now describe an original problem and an original algorithm, for the implementation according to one or other, or both, of the following variants:
Binary constraints: a classifier is constrained to reject the data that does not belong to the class whose task it is to model, and not to disregard them; this makes it possible to refine the model, notably because the rejected data are better isolated by the model. FIG. 8 illustrates the boundary obtained around a class to be modelled (cross symbols), and in the presence of a second class (square symbols), by a 1-class SVM classifier without binary constraints 8.A or with binary constraints 8.B. In the first case, the second class is disregarded, in the second case, it is rejected.
Hot startup: the resolution algorithm can be initialized from an existing solution in order to reduce the retraining time when data change group that is to say when the labels of the training data change.

The implementation of a 1-class SVM classifier making it possible to execute these variants will now be explained.

Let T={(xᵢ, lᵢ), i=1 . . . n}ε( [symbol] ^{d}×{1, 2, . . . , Q})ⁿ be a learning set; this expression reflects the result of a grouping of the data. In the context of the invention, each xᵢ is a vector of acoustic parameters, n is the number of vectors available for the learning, d is the number of acoustic descriptors used, and [symbol] ^{d} is thus the observation space. Each lᵢ corresponds to the label, or number, of the group with which the datum xᵢ is associated. In order to train the 1-class model corresponding to the group qε{1 . . . Q}, use is made of a specific learning set T^{(q)}={(xᵢ,yᵢ^{(q)}), i=1 . . . n}ε( [symbol] ^{d}×{−1, +1})ⁿ with:

$${y}_{i}^{( q )} = \{ \begin{matrix}+ 1 if {l}_{i} = q \\ - 1 if {l}_{i} \neq q\end{matrix}$$

Hereinafter in the description, the exponent (q) is not carried forward to improve legibility. The 1-class SVM problem, known to a person skilled in the art, is as follows:

$${f}_{ℒ , T}^{*} ∈ arg {min}_{f ∈ H} λ {‖ f ‖}_{H}^{2} + {ℛ}_{ℒ , T} ( f )$$

where f is an application, making it possible to establish a score with:

f: [symbol] ^{d}

[symbol]

x→ [symbol] w,φ(x) [symbol] _{H}−b

The operator [symbol] •,• [symbol] _{H}:H×H [symbol] represents the scalar product of two elements in a Hilbert space H with reproducing kernel κ and φ: [symbol] ^{d} [symbol] H is the application of projection into this space. Thus κ(x,x′)= [symbol] φ(x),φ(x′) [symbol] _{H} and, by using a Gaussian kernel κ(x, x′)=exp(−∥x−x′∥/2σ²) where σ, the width of the kernel, is a parameter to be set. The parameters w and b determine a hyperplane in the space H which results in a volume around the data of T in the observation space. Thus, f(xᵢ) is positive if xᵢ is contained within this volume, that is to say if φ(xᵢ) is beyond the hyperplane, and negative otherwise. Finally, the regularization term [symbol] (f) corresponds to the empirical risk:

$${ℛ}_{ℒ , T} ( f ) = \frac{1}{n} {\sum }_{i = 1}^{n} {ω}_{i} ℒ ( f ( {x}_{i} ) , {y}_{i} )$$

where, for each element xᵢ, a weight ωᵢ is set.

The generalized hinge loss function represented in FIG. 7 is given by:

[symbol]

(f,y)=max{0,−yf}

This hinge function will make it possible to discriminate the data. It assigns the datum a penalty if this datum violates the separating hyperplane. A non-zero penalty is assigned to the data such that yᵢ=+1 (respectively yᵢ=−1) situated within (respectively beyond) the separating hyperplane. The latter is determined uniquely by w*ε [symbol] ⁿ and b*ε [symbol] which themselves determine [symbol] uniquely. From these elements, it is possible to reformulate the proposed SVM problem in the following form, by taking into account the bias factor b:

$$( \text{?} , \text{?} ) ∈ arg min \frac{1}{2} {‖ w ‖}_{H}^{2} + \frac{1}{2} {b}^{2} - b + \text{?}$$

$$under constraints \{ \begin{matrix}\text{?} \geq 0 \\ \text{?} \geq - {y}_{i} ( {( w , φ ( \text{?} ) )}_{H} - b )\end{matrix} \\ \text{?} \text{indicates text missing or illegible when filed}$$

where C₁=ωᵢ/2λn. This formulation of the problem brings to mind for a person skilled in the art the problem ν-SVM; note however the addition of the term

$$\frac{1}{2} {b}^{2} ,$$

the benefit of which will be explained hereinbelow, and the presence of the term yᵢ in the second constraint, which reflects the use of the binary constraints.

By using Lagrange multipliers αᵢε [symbol] and the Karush-Kuhn-Tucker conditions, the dual problem is expressed in matrix form:

$$\text{?} W ( α ) = \frac{1}{2} {α}^{T} Ha + \text{?} y$$

$$under constraints c < {α}_{i} < {C}_{i}$$

$$with \text{?} = - {y}_{i} {y}_{1} ( \text{?} ( {x}_{i} , \text{?} ) + 1 )$$

$$\text{?} \text{indicates text missing or illegible when filed}$$

Furthermore, on rewriting the problem, analytical expression for the bias appears, directly derived from the addition of the quadratic term of the bias:

$${b}^{*} = 1 - {\sum }_{i = 1}^{n} {α}_{i} {y}_{i} = 1 - {α}^{T} y$$

Resolution Algorithm

A method by decomposition based on the SMGO (Sequential Maximum Gradient Optimization) algorithm is here applied to the dual 1-class SVM problem presented above, the gradient of which is:

g=Hα+y

The algorithm optimizes the solution α in the direction of the gradient. Take a set I_{WS} of points to be modified in the vector α:

$${I}_{WS} = \{ \text{?} \vert \text{?} \vert ∈ \{ \begin{matrix}q greater absolute values of \\ de \text{?} k = 1 … n ; with \\ {α}_{i} < \text{?} if \text{?} > 0 \\ {α}_{i} > 0 if \text{?} < 0\end{matrix} \} \}$$

$$\text{?} \text{indicates text missing or illegible when filed}$$

It is then possible to give the definition of the partial gradient:

$$\text{?} = \{ \begin{matrix}{g}_{i} si & \text{?} ∈ {I}_{WS} \\ 0 & otherwise\end{matrix} \\ \text{?} \text{indicates text missing or illegible when filed}$$

The updating of the solution is defined by:

α:=α+λ*\tilde{g}

and the updating of the gradient by:

g:=g+λ*H\tilde{g}

It is deduced therefrom that λ*εarg max_{λ}W(α+λg) has the value:

$${λ}^{*} = - \frac{{\tilde{g}}^{T} g}{{\tilde{g}}^{T} H \tilde{g}}$$

Furthermore, in order for the solution to remain within the acceptable domain 0≦αᵢ≦Cᵢ∀i=1 . . . n, the following bounds are applied, these limits being determined, once again, by individual calculations:

$${λ}^{*} \leq {λ}_{sup} = min ( {min}_{i} ( \frac{{C}_{i} - {α}_{i}}{{\tilde{g}}_{i}} ) , {min}_{j} ( \frac{- {α}_{j}}{{\tilde{g}}_{j}} ) )$$

$${λ}^{*} \leq {λ}_{inf} = max ( {max}_{i} ( \frac{- {α}_{i}}{{\tilde{g}}_{i}} ) , {max}_{j} ( \frac{{C}_{j} - {α}_{j}}{{\tilde{g}}_{j}} ) )$$

$$where$$

$$i ∈ \{ k \text{:} {g}_{k} > 0 \}$$

$$and$$

$$j ∈ \{ k \text{:} {g}_{k} < 0 \} .$$

Finally, the algorithm requires a stop criterion which can be a threshold on the average value of the partial gradient or else the measurement of duality gap familiar to a person skilled in the art. The following procedure describes the resolution algorithm as a whole:

1) Choosing a working set I_{WS}

2) Determining the optimum pitch λ*

3) Updating the solution α and the gradient g

4) Repeating 1, 2 and 3 until the stop criterion is reached.

A feasible initialization, that is to say an initialization in the acceptable domain, for the vectors α and g is necessary. It will be noted that, by default, αᵢ=0 ∀i=1 . . . n is an acceptable solution and then g=y in this case. On the other hand, if a different feasible solution is known, this can be used for initialization and the expression “hot startup” of the algorithm then applies. The benefit of starting from a known solution is minimizing the number of iterations needed for the algorithm to converge, that is to say reach the criterion.

Procedure for Updating a Solution

We will now show how an existing solution can be updated. This makes it possible to benefit from the property of hot startup of the algorithm and avoid restarting a complete optimization when the learning set T is modified, that is to say when the distribution of the data in the groups is changed.

The updating procedure is carried out in three steps: a change of domain (which reflects the changing of the constant Cᵢ), a step of updating of the solution vectors and gradient, finally an optimization step (in order to converge towards a new optimum satisfying the stop criterion). It is also necessary to distinguish three types of update: incremental update (new data are added to T), decremental update (data are removed from T) and finally the change of label (a pair of data (xᵢ; yᵢ) in T becomes (xᵢ; −yᵢ)).

The change of domain is an important step when the weights Cₗ associated with the penalty variables ξᵢ depend on n; such is the case for example for the 1-class SVMs where

$${C}_{i} = \frac{1}{vn} ,$$

i=1, . . . , n (νε[0; 1]). The second step relates to the updating of the solution and of its gradient by decomposition of the matrix H. The major advantage of the approach proposed here is that it is not necessary to make use of the calculation of elements of H for the change of domain and that only the columns of H that correspond to the modified elements have to be evaluated for the update. Note also that this technique is entirely compatible with the addition, the deletion or the change of label of a plurality of data simultaneously.

Change of Domain

We define the change of domain of the dual SVM problem as the modification of the constants or weights Cᵢ associated with the penalty variables ξᵢ. It is actually a change of domain for the solution α because αᵢε[0; Cᵢ], ∀i=1, . . . , n. Cᵢ^{(t)} is the constant applied to the problem at an instant t and Cᵢ^{(t+1)} is the constant applied at an instant (t+1).

Property: Given θε [symbol] ⁺* and a pair (w*,b*)ε [symbol] ⁿ× [symbol] , solution of an optimization problem, then (θw*, θb*) is also a solution of the problem.

It can be immediately deduced from this property that if α is a solution of an optimization problem with αhd iεD^{(t)}:=[0; Cᵢ^{(t)}], ∀i=1, . . . , n, then θα is a possible configuration for the initialization of the algorithm, provided that θαᵢεD^{(t+1)}:=[0; Cᵢ^{(t+1)}], ∀i=1, . . . , n. It is then natural for such a change of domain, and in order to strictly respect the inequalities on the αᵢ, to choose

$$θ := {min}_{i} \frac{{c}_{i}^{t}}{{c}_{i}^{( t + 1 )}} .$$

It is then easy to show that the solution updated to reflect the new domain is expressed as:

α←θα

g←θg+(1−θ)y

Decomposition of the Gradient Given n:=m+p, it is proposed to rewrite g, H, α and y according to the following decomposition:

$$g = [ \begin{matrix}{H}_{m , m} & {H}_{m , p} \\ {H}_{m , p}^{T} & {H}_{p , p}\end{matrix} ] ( \begin{matrix}{α}_{m} \\ {α}_{p}\end{matrix} ) + ( \begin{matrix}{y}_{m} \\ {y}_{p}\end{matrix} )$$

It can then be shown that:

$$g = ( \begin{matrix}{\tilde{g}}_{m} \\ {\tilde{g}}_{p}\end{matrix} ) = [ \begin{matrix}{g}_{m} \\ {H}_{m , p}^{T} {α}_{m} + {y}_{p}\end{matrix} ] + [ \begin{matrix}{H}_{m , p} \\ {H}_{p , p}\end{matrix} ] {α}_{p}$$

From this decomposition, the following expressions of incremental update immediately appear:

$${α}_{m} ← ( \begin{matrix}{α}_{m} \\ {α}_{p}\end{matrix} )$$

$$g ← [ \begin{matrix}{g}_{m} \\ {H}_{m , p}^{T} {α}_{m} + {y}_{p}\end{matrix} ] + [ \begin{matrix}{H}_{m , p} \\ {H}_{p , p}\end{matrix} ] {α}_{p}$$

An initialization for αₚ is necessary. By default, it is proposed to choose αₚ=0ₚ (where 0ₚ is a zero vector of size p). Similarly the expressions of decremental update are:

$${α}_{m} ← {α}^{\backslash {α}_{p}}$$

$$g ← {\tilde{g}}_{m} - {H}_{m , p} {α}_{p}$$

Finally, in the case of a change of labels, it is a question of modifying the labels of p elements, or yₚ←−yₚ. Another consequence of this modification is that H_{p,m}←−H_{p,m}. Take the learning set T⁽ⁿ⁾ containing n data. If a solution α is known, as well as the gradient after convergence g, then it is possible to modify the labels of p data and update this solution in order to restart an optimization process by applying the preceding gradient breakdown formula to update the gradient. Provided that α is compatible with the feasible domain for α^{new}, then:

$${α}^{new} ← ( \begin{matrix}{α}^{\backslash {α}_{p}} \\ {α}_{p}^{new}\end{matrix} )$$

$${g}^{new} ← [ \begin{matrix}{\tilde{g}}_{m} - {H}_{m , p} {α}_{p} \\ - {H}_{m , p}^{T} {α}_{m} - {y}_{p}\end{matrix} ] + [ \begin{matrix}- {H}_{m , p} \\ {H}_{p , p}\end{matrix} ] {α}_{p}^{new}$$

$${y}^{new} ← ( \begin{matrix}{y}^{\backslash {y}_{p}} \\ - {y}_{p}\end{matrix} )$$

An initialization for αₚ^{new} is also necessary. By default, it is proposed to choose αₚ^{new}=0ₚ.

### Advantages

The method and the system according to the invention allow for a modelling of audio data by multiple support vector machines, of 1-class SVM type, as proposed in the preceding description. The learning of each subclass is performed jointly.

The invention notably makes it possible to address the problem of how to model a set of audio data in a representation space with N dimensions, N varying from 10 to more than 1000, for example, while exhibiting a robustness to the changes over time of the environment characterized and a capacity to process a large number of data in a large dimension. In effect, it is not necessary to keep matrices of large dimension in memory; only the gradient and solution vectors need to be stored.

The method according to the invention makes it possible to perform a modelling of each group of data as a closed region (closed, delimited) in the observation space. This approach notably offers the advantage of not producing a partitioning of the representation space, the unmodelled regions corresponding to an abnormal event or signal. The method according to the invention therefore retains the properties of the 1-class approaches known to a person skilled in the art, and in particular the novelty discovery (novelty detection), which makes it possible to detect the abnormal events or to create new subclasses of the normal class (ambiance) if a high density of data were to be detected.

1. A method for detecting abnormal events in a given environment, by analyzing audio signals recorded in said environment, the method comprising a step of modelling a normal ambiance by at least one model and is therefore a step using model or models, the method comprising:
a model construction step comprising at least the following steps:
a) a step of unsupervised initialization of Q groups consisting of a grouping by classes, or subspace of the normal ambiance, of the audio data representing the learning signals S_{A}, Q being set and greater than or equal to 2;
b) a step of definition of a model of normality consisting of 1-class SVM classifiers, each classifier representing a group, each group of learning data defines a sub-class in order to obtain a model of normality consisting of several classifiers of 1-class SVM, each one being adapted to a group, or sub-set of data said to be normal derived from the learning signals representative of the ambiance;
c) a step of optimisation of the groups that uses the model during the modelling step so as to redistribute the data in the Q different groups;
d) repetition of the steps b and c until a stop criterion C₁, is checked and a model M is obtained;
wherein the step of use of the model(s) M obtained from the construction step comprising at least the following steps:
e) the analysis of an unknown audio signal S_{T} obtained from the environment to be analyzed, the unknown audio signal is compared to the model M obtained from the model construction step, and assigns, for each 1-class SVM classifier, a score fq, and
f) a comparison of all the scores fq obtained by the 1-class SVM classifiers using decision rules in order to determine the presence or absence of an anomaly in the audio signal analyzed.

2. The method according to claim 1, wherein the audio data being associated with segmentation information, the method assigns a same score value fq to a set of data constituting one and the same segment, a segment corresponding to a set of similar and consecutive frames of the audio signal, said score value being obtained by calculating the average value or the median value of the scores obtained for each of the frames of the signal analyzed.

3. The method according to claim 1, wherein 1-class SVM classifiers are used with binary constraints.

4. The method according to claim 1, wherein when a plurality of models Mj are determined, each model being obtained by using different stop criteria C₁ and/or different initializations I, a single model is retained by using statistical or heuristic criteria.

5. The method according to claim 1, wherein a plurality of models Mj are determined and retained during the model construction step, for each of the models Mj, the audio signal is analyzed and the presence or absence of anomalies in the audio signal is determined, then these results are merged or compared in order to decide categorically as to the presence or absence of an anomaly in the signal.

6. The method according to claim 1, wherein during the group optimization step, the number Q of groups is modified by creating/deleting one or more groups or subclasses of the model.

7. The method according to claim 1, wherein during the group optimization step, the number Q of groups is modified by merging/splitting one or more groups or subclasses of the model.

8. The method according to claim 1, wherein the model used during the usage step d) is updated by executing one of the following steps: the addition of data or audio signals or acoustic descriptors extracted from the audio signals in a group, the deletion of data in a group, the merging of two or more groups, the splitting of a group into at least two groups, the creation of a new group, the deletion of an existing group, the placing on standby of the classifier associated with a group, the reactivation of the classifier associated with a group.

9. The method according to claim 1, wherein during the step c), a criterion is used for the optimum distribution of the audio signals in the Q different groups chosen from the following list:
the fraction of the audio data which changes group after an iteration below a predefined threshold value,
a maximum number of iterations reached,
a criterion of information on the audio data and the modelling of each group reaching a predefined threshold value.

10. The method according to claim 1, wherein the K_averages method is used for the group initialization step.

11. A system for determining abnormal events in a given environment, by the analysis of audio signals detected in said environment by executing the method as claimed in claim 1, comprising at least:
an acoustic sensor for detecting sounds, sound noises present in an area to be monitored linked to a device containing a filter and an analogue-digital converter,
a processor comprising a module for preprocessing the data, and a learning module,
a database, comprising models corresponding to classes of acoustic parameters representative of an acoustic environment considered to be normal,
one or more acoustic sensors each linked to a device comprising a filter and an analogue-digital converter,
a processor comprising a preprocessing module then a module for recognizing processed data, the preprocessing module is linked to the database, adapted to execute the steps of the method,
a means for displaying or detecting abnormal events.
